(19) United States
(12) Patent Application Publication
(10) Pub. No.: US 2009/0015922 A1
(43) Pub. Date: Jan. 15, 2009

(54) Writing a diffractive structure

(75) Inventor: Pierre St. Hilaire, Belmont, CA (US)

Correspondence Address: VAN PELT, YI & JAMES LLP, 10050 N. FOOTHILL BLVD #200, CUPERTINO, CA, 95014, US

(73) Assignee: AllView Research LLC, Belmont, CA (US)

(21) Appl. No.: 12/215,680

(22) Filed: Jun. 27, 2008

Related U.S. Application Data
(60) Provisional application No. 60/937,721, filed on Jun. 29, 2007.

(51) Int. Cl. G02B 27/46

(52) U.S. Cl. 359/559

(57) ABSTRACT

Writing a diffractive structure is disclosed. A reference modulated beam is generated. An object modulated beam is generated. A diffractive structure is written using an interference between the reference modulated beam and the object modulated beam. A system for writing a diffractive structure comprises a reference generator for generating a reference modulated beam; an object generator for generating a object modulated beam; and a writer for writing a diffractive structure using an interference between the reference modulated beam and the object modulated beam.

### CROSS REFERENCE TO OTHER APPLICATIONS

This application claims priority to U.S. Provisional Patent Application No. 60/937,721 (Attorney Docket No. ALLVP006+) entitled WRITING DIFFRACTIVE STRUCTURES USING A SELF REFERENCING SCANNING INTERFEROMETER filed Jun. 29, 2007 which is incorporated herein by reference for all purposes.

### BACKGROUND OF THE INVENTION

Many applications such as display holography, fiber Bragg gratings, or the fabrication of photonics crystals, require being able to write sub-micrometer structures with a very high level of accuracy. Traditional methods for doing so involve either optical holography or photolithography. However, one problem is that optical holography suffers from being a slow (e.g., not able to be replicated) and hence expensive technique. Also, another problem is that photolithography typically requires a “step and repeat” process to build up complex structures as well as to write to large areas and so similarly an expensive technique, and perhaps more troublesome is that photolithography, since it is inherently a two dimensional technique is not appropriate for writing some types of three dimensional structures that are required for holographic or Bragg structures.

### BRIEF DESCRIPTION OF THE DRAWINGS

Various embodiments of the invention are disclosed in the following detailed description and the accompanying drawings.

FIG. 1 is a block diagram illustrating an embodiment of a system for writing a diffractive structure.

FIG. 2A is a block diagram illustrating an embodiment of a scanning interferometer with gratings.

FIG. 2B is a block diagram illustrating an embodiment of a scanning interferometer with gratings.

FIG. 3 is a block diagram illustrating an embodiment of a Fourier filter.

FIG. 4 is a flow diagram illustrating an embodiment of a process for writing a diffractive structure.

FIGS. 5A, 5B and 5C are diagram illustrating embodiments of scanning in a writing system for a diffractive structure.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Writing a diffractive structure is disclosed. A reference modulated beam is generated. An object modulated beam is generated. A diffractive structure is written using the interference between the reference modulated beam and the object modulated beam. In order to achieve the writing of different orientation of fringes in a target material, both the reference beam and the object beam are modulated.

In some embodiments, the reference modulated beam and the object modulated beam are both generated by diffracting an illumination beam using a spatial light modulator. In some embodiments, the modulation for the reference uses one set of spatial frequencies and the modulation for the object uses another set of spatial frequencies; a Fourier filter can be used so as to pass only the reference modulated beam and the object modulated beam to the target material.

In some embodiments, diffractive structures are written using a self referencing scanning interferometer. The diffractive structures are written by writing holographic fringes in a material. The diffractive structures are written using a continual scanning motion and can be used with either continuous wave (CW) or pulsed lasers.

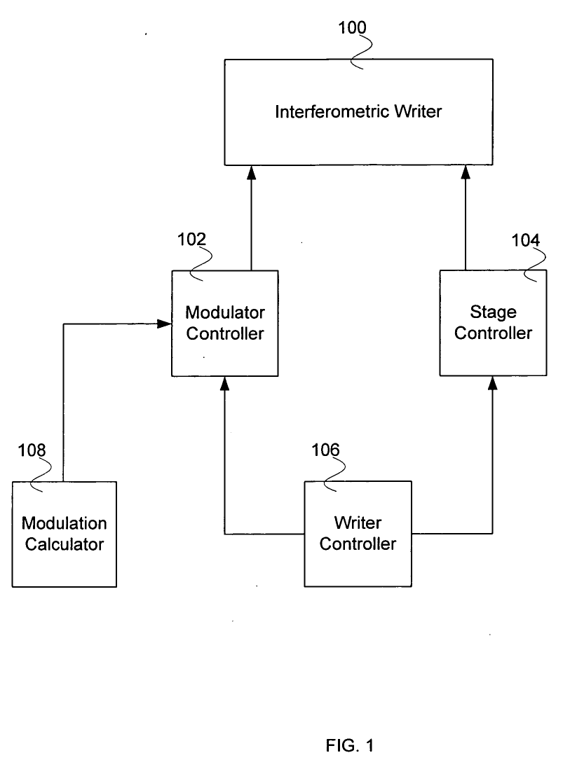

FIG. 1 is a block diagram illustrating an embodiment of a system for writing a diffractive structure. In the example shown, the system includes interferometric writer 100, modulation controller 102, stage controller 104, writer controller 106, and modulation calculator 108. Modulation calculator 108 calculates a reference beam modulation and an object beam modulation for a modulator of interferometric writer 100. The modulations are calculated taking into account the motion of the material and/or modulator and are designed to achieve the writing of a desired diffractive structure. In some embodiments, the diffractive structure is written by exposing a photosensitive material in three dimensions and later developing the material to produce the desired diffractive structure. In some embodiments, the photosensitive material is a linearly responsive material or a non-linearly responsive material (e.g., photoresist, photopolymer, 2-photon material, etc.).

Modulation calculator 108 loads calculated modulations to modulator controller 102 Writer controller 106 indicates to modulator controller 102 the appropriate modulations to load to interferometric writer 100 for the positions of the modulator and/or target (e.g., photosensitive material) as set by stage controller 104. Using the modulations and positions of the modulator and/or target, interferometric writer 100 exposes the target. After the target is exposed, the target can be developed to produce a desired diffraction structure.

In some embodiments, a diffractive profile stored in a computer is written onto the modulator (e.g., spatial light modulator (SLM)). The diffractive profile written comprises two components that are superposed:
1) A diffractive profile that corresponds to a reference beam in conventional holography this diffractive profile is generally relatively simple (i.e. plane or spherical wavefronts) since its purpose is to serve as a carrier wave; and
2) A diffractive profile that corresponds to the object beam in holography this profile corresponds to the information content of the hologram and can be very complex.

Because of the superposition principle it is possible to combine these two profiles onto the same section of the modulator by adding them during computation. In some embodiments, the reference and object profiles are spatially superimposed, but their spatial frequency components do not overlap; the total spatial frequency spectrum available from the modulator is allocated between the object and reference spectra. Typically the object beam spectrum, which contains the hologram information, is considerably wider. The light illuminating the modulator is diffracted into two wavefronts corresponding to the reference and object beam. Other wavefronts, corresponding to the zero^{th} and higher diffracted orders, are also present and need to be filtered out.

Interferometric writer 100 is self-referencing: both the object and reference beams are created from the same modulator, and their respective optical paths are processed by the same components. This renders the interferometer very robust to vibrations or fluctuations in the laser frequency. Also, note that the interferometer allows for the continuous scanning of a desired fringe pattern over an arbitrarily large surface. The scanning operation of the interferometer follows: The material to be written upon is mounted on a translation stage that moves at a constant speed V. As the stage translates, a new fringe pattern is loaded onto the modulator (e.g., an SLM). That new fringe pattern consists of the original pattern translated by a factor VT/M, onto which new pixels corresponding to the desired fringe pattern are appended. T designates the time interval between successive modulator frames. M is the magnification factor between the modulator and the target. In this way the fringes written onto the material approximately track the position of the fringes on the modulator. However, this tracking is only completely effective only at discrete time intervals T, which is typically determined by the frame rate of the modulator. A truly continuous scan can be achieved if the modulator is mounted on a highly accurate translation stage (e.g., a piezodriven stage). The modulator translation stage effectively tracks the writer surface by translating at a speed V/M and is reset to its initial position after an interval NT where N is an integer. The net result will be a fringe pattern that stays precisely registered on the write plane while scanning continuously across it. A shutter is used to blank the laser while a new frame is loaded onto the modulator and/or when the piezo stage is reset. The net result of this mode of operation is that of a holographic fringe pattern being scrolled continuously across the recording medium, with no phase discontinuity. The only blanking intervals are due to the refresh time of the modulator and the resetting of the piezo stage, and these intervals comprise a very small fraction of the total write time. Hence this technique allows for the efficient recording of a holographic fringe pattern with a CW laser because of its high duty cycle when compared to a “step and repeat” procedure. It is of note that this technique is also applicable with pulsed lasers.

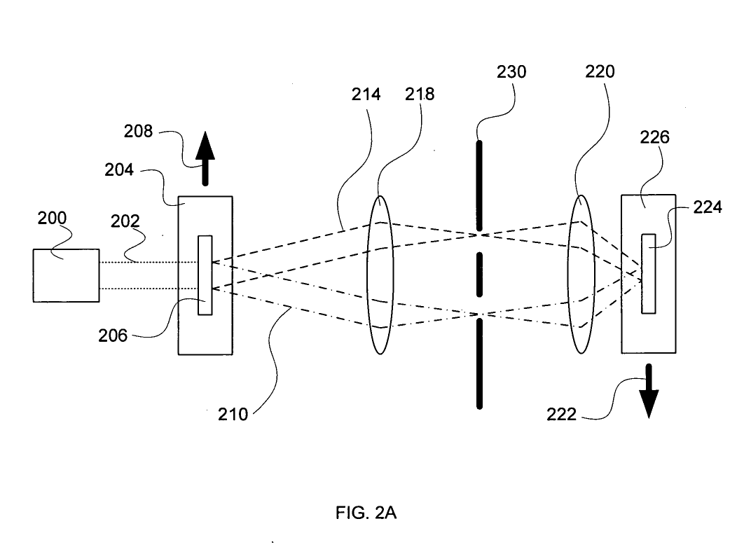

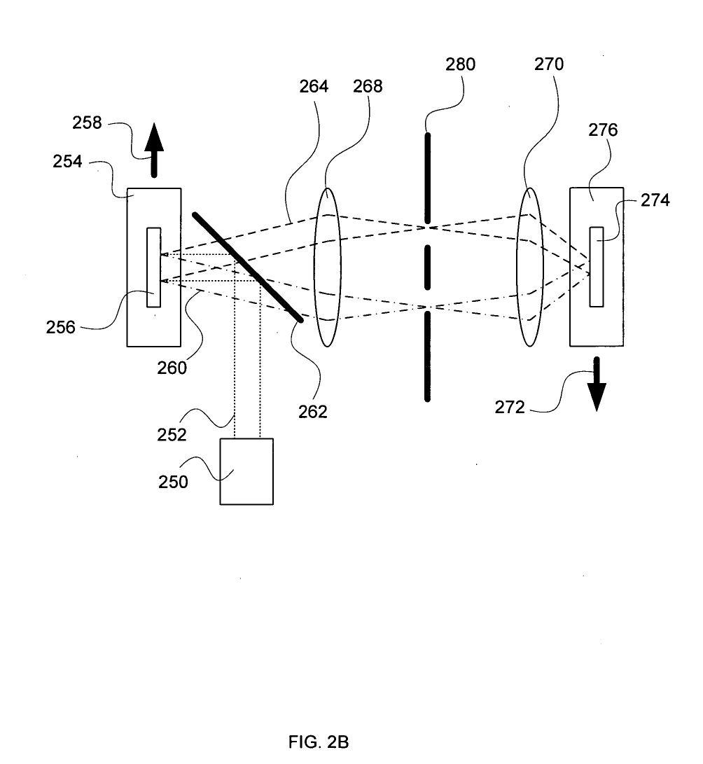

FIG. 2A is a block diagram illustrating an embodiment of a scanning interferometer with gratings. In the example shown, coherent light source 200 illuminates modulator 206 by being the source for a beam propagating along 202. In various embodiments, coherent light source 200 includes a CW laser, a pulsed laser, or any other appropriate coherent light source. In various embodiments, coherent light source 200 includes optics to expand a beam, an optical isolator, a conditioning polarization optic, or any other appropriate optical element. Modulator 206 is coupled to moving object 204 moving in a direction (e.g., a direction such as indicated by arrow 208). In some embodiments, modulator 206 comprises a spatial light modulator (SLM), which is a device that can impart either a phase or an amplitude profile onto an incoming laser wavefront by modulating individual pixels in the device. In some embodiments, modulator 206 is mounted on a high accuracy linear stage capable of nanometer resolution (typically a piezoelectric stage). Illuminating modulator 206 generates diffracted beams including two beams propagating along 214 and 210. In some embodiments, the two beams comprise a reference beam and an object beam. In some embodiments, the reference beam and the object beam correspond to +1 and −1 order diffracted beams or vice versa. Beams other than the diffracted beams of interest are blocked using filter 230; For example, the zero^{th} beam and/or higher order diffracted beams are blocked. The two beams are imaged by an optical system represented by lens 218 and lens 220 onto target 224. In various embodiments, the optical system comprises a single lens, a group of lenses, two lens groups, two lens groups comprising an afocal telescope, an imaging system with a magnification factor (e.g., magnification M) such as is similar to a microscope, or any other appropriate optical system.

In some embodiments, the optical system comprises a confocal arrangement of two lenses (e.g., lens 218 and lens 220) of focal length f1 and f2 (or two lens groups of equivalent focal lengths). Modulator 206 is placed at the front focal plane of lens 218. The lens assembly fulfills multiple roles: a) it projects a real image of modulator 206 onto the writing plane with a magnification M=f1/f2; b) it multiplies the angular extent of the diffracted rays by 1/M; and c) it allows for a filtering of the unwanted 0th and higher orders by putting an appropriately shaped mask in the focal plane of lens 218 (Fourier plane filtering).

After spatial filtering using Fourier filter 230, modulator 206 is imaged onto the write plane at the required magnification. A telescope constituted by an optic system (e.g., lens 218 and lens 220) can match a desired range of angles at the writing plane to the diffraction angles of the modulator, which are typically smaller. It should be noted that the entrance and exit pupils of the optical system coincide with modulator 206 and image planes respectively. The optical system is thus telecentric. At the writing plane, the magnified reference and object beams interfere to create a fringe pattern corresponding to the desired profile.

Target 224 is coupled to moving object 226 moving in a direction (e.g., a direction such as indicated by arrow 222. The two beams interfere together at target 224.

FIG. 2B is a block diagram illustrating an embodiment of a scanning interferometer with gratings. In the example shown, coherent light source 250 illuminates modulator 256 by being the source for a beam propagating along 252 and reflecting off of beam splitter 262. In various embodiments, coherent light source 250 includes a CW laser, a pulsed laser, or any other appropriate coherent light source. In various embodiments, coherent light source 250 includes optics to expand a beam, an optical isolator, a conditioning polarization optic, or any other appropriate optical element. Modulator 256 is coupled to moving object 254 moving in a direction (e.g., a direction such as indicated by arrow 258). In some embodiments, modulator 256 comprises a spatial light modulator (SLM), which is a device that can impart either a phase or an amplitude profile onto an incoming laser wavefront by modulating individual pixels in the device. In some embodiments, modulator 256 is mounted on a high accuracy linear stage capable of nanometer resolution (typically a piezoelectric stage). Illuminating modulator 256 generates diffracted beams including two beams propagating along 264 and 260. In some embodiments, the two beams comprise the reference modulated beam and the object modulated beam. In some embodiments, the reference beam and the object beam correspond to +1 and −1 order diffracted beams or vice versa. Beams other than the diffracted beams of interest are blocked using filter 280; For example, the zero^{th} beam and/or higher order diffracted beams are blocked. The two beams are imaged by an optical system represented by lens 268 and lens 270 onto target 274. In various embodiments, the optical system comprises a single lens, a group of lenses, two lens groups, two lens groups comprising an afocal telescope, an imaging system with a magnification factor (e.g., magnification M) such as is similar to a microscope, or any other appropriate optical system.

In some embodiments, the optical system comprises a confocal arrangement of two lenses (e.g., lens 268 and lens 270) of focal length f1 and f2 (or two lens groups of equivalent focal lengths). Modulator 256 is placed at the front focal plane of lens 268. The lens assembly fulfills multiple roles: a) it projects a real image of modulator 256 onto the writing plane with a magnification M=f1/f2; b) it multiplies the angular extent of the diffracted rays by 1/M; and c) it allows for a filtering of the unwanted 0th and higher orders by putting an appropriately shaped mask in the focal plane of lens 268 (Fourier plane filtering).

After spatial filtering using Fourier filter 280, modulator 256 is imaged onto the write plane at the required magnification. A telescope constituted by an optic system (e.g., lens 268 and lens 270) can match a desired range of angles at the writing plane to the diffraction angles of the modulator, which are typically smaller. It should be noted that the entrance and exit pupils of the optical system coincide with modulator 256 and image planes respectively. The optical system is thus telecentric. At the writing plane, the magnified reference and object beams interfere to create a fringe pattern corresponding to the desired profile.

Target 274 is coupled to moving object 276 moving in a direction (e.g., a direction such as indicated by arrow 272.

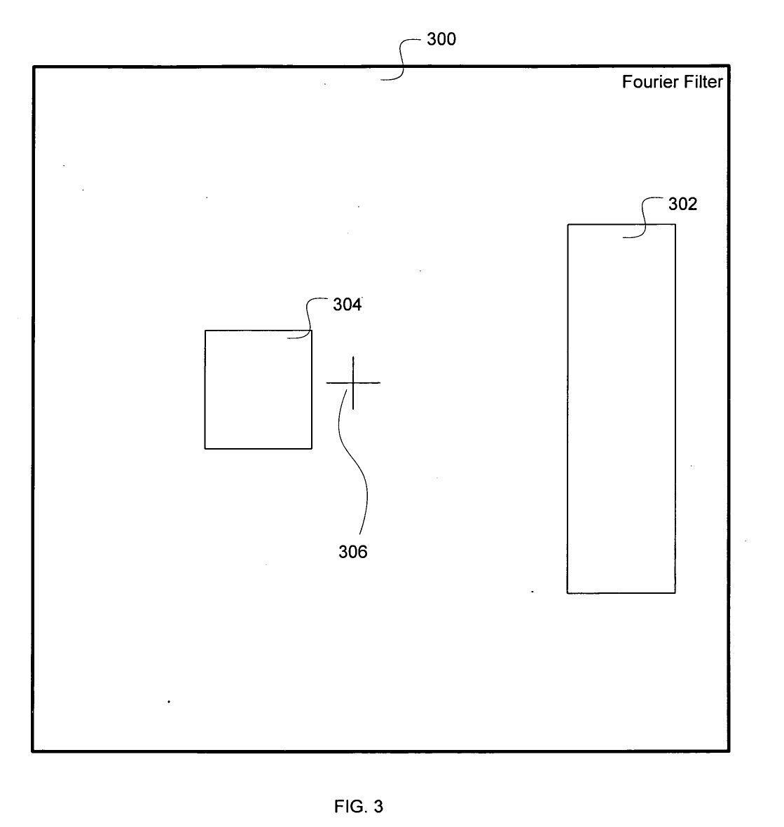

FIG. 3 is a block diagram illustrating an embodiment of a Fourier filter. In some embodiments, Fourier filter 300 is used to implement filter 230 of FIG. 2A and/or filter 280 of FIG. 2B. In the example shown, Fourier filter 300 includes object modulated beam filter 302, reference modulated beam window 304, and optical axis reference mark 306. The spatial frequency content of the modulation of the object beam is different from the spatial frequency content of the modulation of the reference beam. Fourier filter 300 is able to pass only the object modulated beam by appropriately positioning object modulated beam filter 302. Also, Fourier filter 300 is able to pass only the reference modulated beam by appropriately positioning reference modulated beam filter 304. In various embodiments, Fourier filter 300 includes lenslets, gratings, prisms, liquid crystal elements, or any other appropriate optical elements in object modulated beam filter 302 and/or reference modulated beam filter 304.

In some embodiments, Fourier filter 300 has a mask that blocks the 0^{th} order propagating down the optical axis and lets only the appropriate diffracted wavefronts from two diffracted beams (e.g., the +1 order of the object beam and −1 order of the reference beam). Because the spatial frequency spectra of reference and object beams are calculated not to overlap, the mask effectively ensures that only the two diffracted beams (e.g., +1 object beam and −1 reference beam) will be present on the writing plane. It should be noted that the 0^{th} order need not necessarily coincide with the optical axis: Illuminating modulator (e.g., a spatial light modulator) at an angle other than normal will shift the 0^{th} order away from the axis.

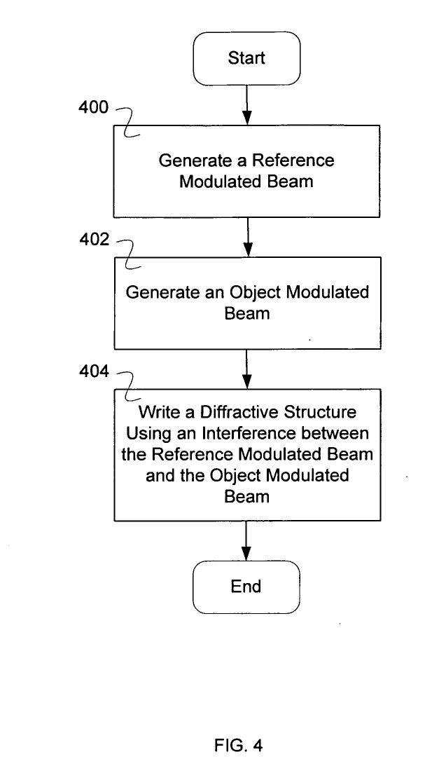

FIG. 4 is a flow diagram illustrating an embodiment of a process for writing a diffractive structure. In the example shown, in 400 a reference modulated beam is generated. In 402, an object modulated beam. In 404, a diffractive structure is written using an interference between the reference modulated beam and the object modulated beam.

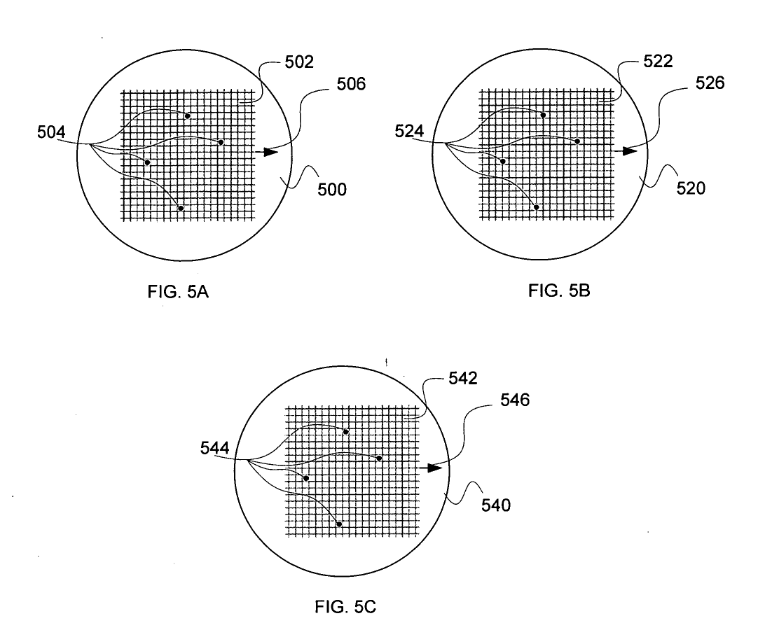

FIGS. 5A, 5B and 5C are diagram illustrating embodiments of scanning in a writing system for a diffractive structure. In the example shown in FIG. 5A, target 500 has points of reference 504 superimposed with modulator image 502. Target 500 moves and therefore modulator image 502 moves (e.g., in the direction of arrow 506) with respect to target 500 and points of reference 504. In the example shown in FIG. 5B, target 520 has points of reference 524 superimposed with modulator image 522. Target 520 has moved and continues to move (e.g., in the direction of arrow 526) and therefore modulator image 522 has moved and continues to move with respect to target 520 and points of reference 524. In the example shown in FIG. 5C, target 540 has points of reference 544 superimposed with modulator image 542. Target 540 has moved and continues to move (e.g., in the direction of arrow 546) and therefore modulator image 542 has moved and continues to move with respect to target 540 and points of reference 544.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method for writing a diffractive structure comprising:
generating a reference modulated beam;
generating a object modulated beam;
writing a diffractive structure using an interference between the reference modulated beam and the object modulated beam.

2. A method as in claim 1, wherein the reference modulated beam is generated by diffracting an illumination beam using a spatial light modulator.

3. A method as in claim 1, wherein the object modulated beam is generated by diffracting an illumination beam using a spatial light modulator.

4. A method as in claim 1, wherein the reference modulated beam comprises a first set of spatial frequency components and the object modulated beam comprises a second set of spatial frequency components, wherein the first set of spatial frequency components and the second set of spatial frequency components do not overlap.

5. A method as in claim 4, further comprising passing only the reference modulated beam and the object modulated beam by using a Fourier filter.

6. A method as in claim 4, wherein the reference modulated beam and the object modulated beam comprise different diffracted order beams.

7. A method as in claim 1, further comprising passing the reference modulated beam and the object modulated through an optical system that provides magnification.

8. A method as in claim 1, wherein the diffractive structure is written in a material that is coupled to a mover.

9. A method as in claim 8, wherein the material comprises a photosensitive material.

10. A method as in claim 8, wherein a spatial modulator is modulated to correspond with the motion of the material.

11. A method as in claim 8, wherein a spatial modulator is moved to correspond with the motion of the photosensitive material.

12. A system for writing a diffractive structure comprising:
a reference generator for generating a reference modulated beam;
an object generator for generating a object modulated beam;
a writer for writing a diffractive structure using an interference between the reference modulated beam and the object modulated beam.

13. A system as in claim 12, wherein the reference modulated beam is generated by diffracting an illumination beam using a spatial light modulator.

14. A system as in claim 12, wherein the object modulated beam is generated by diffracting an illumination beam using a spatial light modulator.

15. A system as in claim 12, wherein the reference modulated beam comprises a first set of spatial frequency components and the object modulated beam comprises a second set of spatial frequency components, wherein the first set of spatial frequency components and the second set of spatial frequency components do not overlap.

16. A system as in claim 15, further comprising a Fourier filter, wherein the Fourier filter passes only the reference modulated beam and the object modulated beam.

17. A system as in claim 15, wherein the reference modulated beam and the object modulated beam comprise different diffracted order beams.

18. A system as in claim 15, further comprising an optical system, wherein the optical system provides a magnification for the reference modulated beam and the object modulated.

19. A system as in claim 15, wherein the diffractive structure is written in a material that is coupled to a mover.

20. A system as in claim 19, wherein the material comprises a photosensitive material.

21. A system as in claim 19, wherein a spatial modulator is modulated to correspond with the motion of the material.

22. A system as in claim 21, wherein a spatial modulator is moved to correspond with the motion of the photosensitive material.

23. A computer program product for calculating a modulation, the computer program product being embodied in a computer readable storage medium and comprising computer instructions for:
calculating a reference modulation for a reference modulated beam;
calculating an object modulation for an object modulated beam;
providing the reference modulation and the object modulation that enables a modulator to generate a reference modulated beam and an object modulated beam, wherein an interference between the reference modulated beam and the object modulated beam is able to write a diffractive structure.
